(19) United States
(12) Patent Application Publication
(10) Pub. No.: US 2018/0238110 A1
(43) Pub. Date: Aug. 23, 2018

(54) Portable, adjustable, privacy, wind and shade apparatus

(71) Applicant: Sherri Lesli, Kempner, TX (US)

(72) Inventor: Sherri Lesli, Kempner, TX (US)

(21) Appl. No.: 15/932,398

(22) Filed: Feb. 26, 2018

Related U.S. Application Data
(60) Provisional application No. 62/600,404, filed on Feb. 21, 2017.

(51) Int. Cl. E06B 9/42; E04F 10/02

(52) U.S. Cl. CPC E06B 9/42; E06B 2009/402; E04F 10/02

(57) ABSTRACT

A portable apparatus that provides privacy, wind reduction, and shade to a desired location is disclosed. The apparatus comprises a shade fabric that fits over vertical posts, each post has a ground stake attached to the bottom end. The ground stakes allow for simple placement and securing the unit in desired locations. For additional stability, a horizontal pole fits to the top of a two vertical posts by using connectors that hold the vertical posts in place. The center connecter is adjustable so the apparatus can positioned at various angles. The apparatus can easily be repositioned or relocated throughout the day as the sun moves or the wind shifts. The unit is light weight and can easily be taken apart, the fabric rolled up, and all parts fit into a carry bag for convenient transportation and storing while not in use.

### CROSS REFERENCES TO RELATED APPLICATIONS

This application claims priority to Provisional Patent Application No. 62/600,404 entitled “Portable, Adjustable, privacy, wind and shade protection apparatus,” filed Feb. 21, 2017, of which the full disclosure of the application is incorporated herein by reference for all purposes.

### BACKGROUND OF THE INVENTION

### Field of the Invention

The present invention relates to weather protection and privacy, in particular, a portable, adjustable, apparatus that restricts the view of an area and provides protection from harmful sun and reduces the impact of wind that is easily set up, taken down, lightweight for transporting, and is economical.

### Brief Description of the Related Art

As there are numerous reasons people and pets spend time outdoors there are needs for protection from sun and heat, wind, and times where privacy from others is desired. It is known that the use of pop up shade covers, umbrellas, patio blinds, and tarps are commonly used to shade areas. Tarps and patio blinds are also used for wind and privacy use. As for the pop up shade covers, they are generally heavy to transport, provide only overhead shade, and are easily blown or damaged by wind. Umbrellas must be held which limits the users movement and the larger umbrellas with heavy stands are not convenient to transport and are easily blown or damaged in wind. Patio blinds must be installed or affixed, thus they are limited to use in a location and are not portable. As for tarps, they must be tied to something which limits where they can be used, as there is not always something convenient to tie them to in a desired location.

In this respect, the portable, adjustable, privacy, wind and shade apparatus according to the present invention substantially departs from the conventional concepts, and in doing so provides an apparatus primarily developed for the purpose of restricting the view of an area, reducing wind impact, providing shade from harmful sunrays, that is lightweight and easy to transport.

### SUMMARY OF THE INVENTION

In view of the foregoing disadvantages inherent in the known types of privacy and shading devices of various designs now present in the prior art, the present invention provides a new privacy and shading system that overcomes the disadvantages of such prior art.

To attain this, the present invention provides a lightweight, portable, adjustable shade and privacy unit. In particular, a shade fabric that fits over vertical posts, each post having a ground stake on the bottom end to secure and stabilize the system in a desired location. For additional stability to the system, a horizontal pole fits to the top of a two vertical posts by using a connector that will hold the vertical posts in place. An adjustable connector placed on the center vertical post and connected to a pair of horizontal poles allows the unit to be set up at various angles. The tubular vertical post may be telescoping so that the unit can be raised or lowered as desired. The unit can easily be repositioned or relocated throughout the day as the sun moves or the wind shifts. The unit can easily be taken apart, the fabric rolled up, and all parts fit into a carry bag for convenient transportation and for storing while not in use.

### BRIEF DESCRIPTION OF THE DRAWING

The detail structure, the applied principle, the function and the effectiveness of the present invention can be more fully understood with reference to the following description and accompanying drawings, in which:

FIG. 1 is a perspective illustration of the embodiment of the present invention.

FIG. 2 is a perspective view of the embodiment of the present invention shown in FIG. 1 positioned at an angle.

FIG. 3 is a perspective illustration of the carry bag for placing all parts of apparatus during transport or storage.

### DETAILED DESCRIPTION OF THE INVENTION

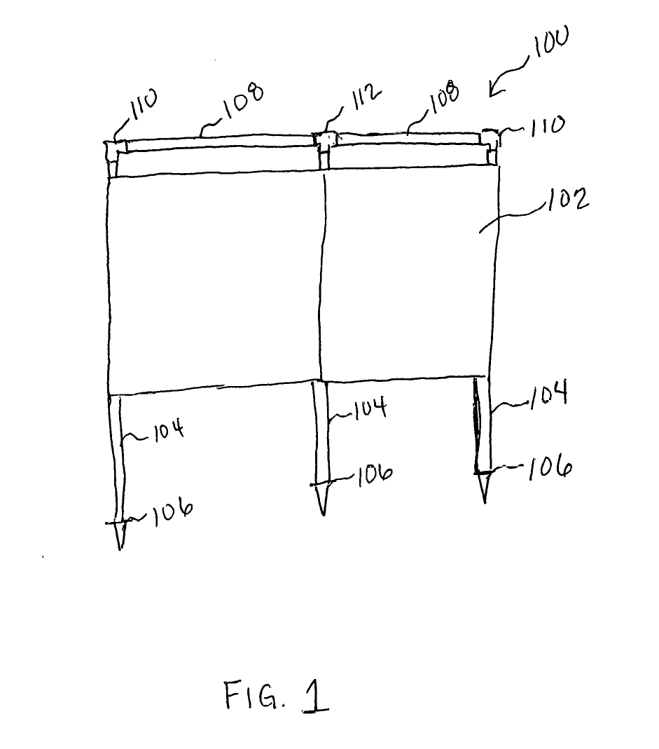

Referring to FIG. 1 shade fabric 102, or other type of fabric, fits over vertical posts 104 that have ground stakes 106 on the bottom to that stake into the ground, or large plant pots, to secure unit 100 in desired location. For additional stability, horizontal poles 108 fit to connectors 110 that fit to the top of vertical posts 104. The vertical posts 104 may be adjustable by twist and lock, snap pins, or other means for extending or recessing the posts to desired heights. The center connector 112 can be adjusted so that the unit can be set up at desired angles. The unit 100 is shown as it would be set up straight as to create a privacy wall or to shade a desired area. The shade fabric 102, filters sun rays and reduces temperature in shaded area, reduces the impact of wind, and restricts the view of an area.

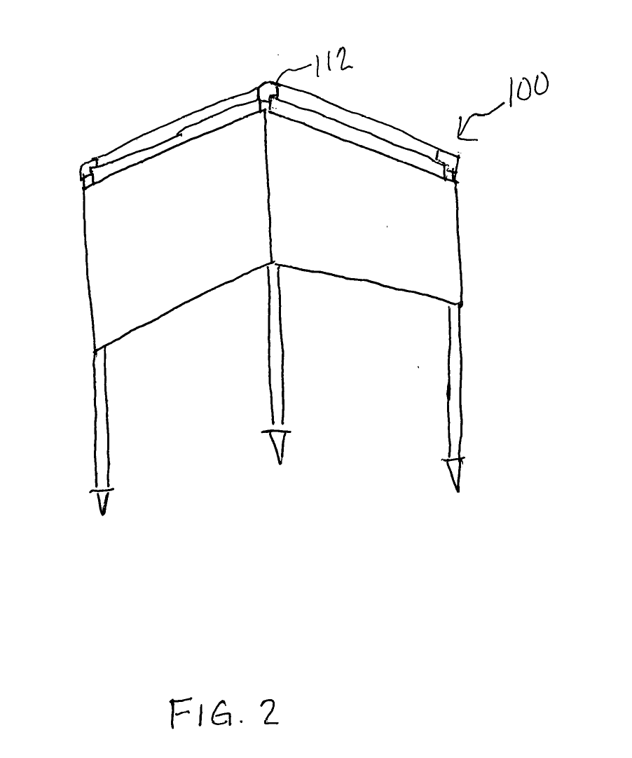

Referring to FIG. 2 is a view of the unit 100 of FIG. 1 shown with the center connector 112 adjusted at an angle which gives the unit more stability in windy conditions and provides more options for desired placement around a patio, a swimming pool, a picnic area, a dog house, a camp site, etc.

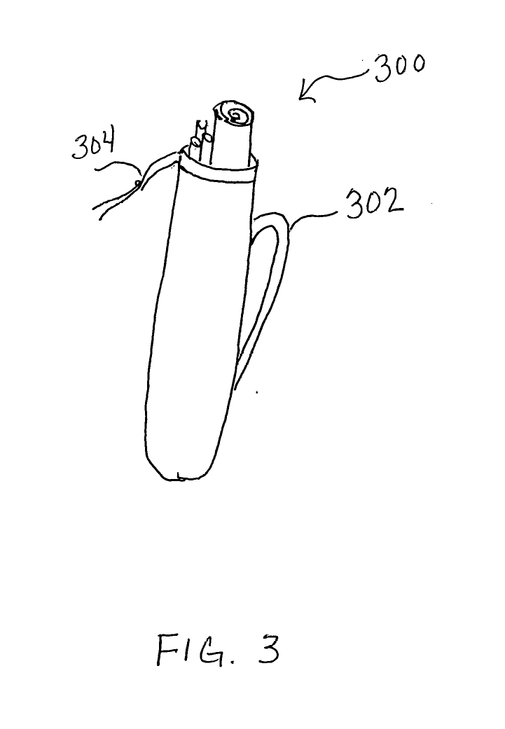

Referring to FIG. 3 showing the carry bag 300 for transport of the embodiment of the present invention includes a shoulder strap 302, and a drawstring 304 to tighten the top of the carry bag 300 to hold in all parts of unit 100 of FIG. 1 during transport or storage.

While the invention has been described with respect to preferred embodiment, it will be clear to those skilled in the art that modifications and improvements may be made to the invention without departing from the spirit and scope of the invention. Therefore, the invention is not to be limited by the specific illustrative embodiment, but only by the appended claims.

What is claimed is:

1. A portable, adjustable, privacy, wind and shade apparatus comprising, in combination:
a fabric that fits over tubular vertical posts;
a set three of tubular vertical posts;
a pair of tubular horizontal poles;
a pair of connectors that connect to the vertical posts and to the horizontal poles;
a ground stake attached to the end of each vertical post;
a carry bag for transporting and or storage.

2. The portable, adjustable, privacy, wind and shade apparatus as set forth in claim 1, wherein the tubular vertical posts are telescoping.

3. The portable, adjustable, privacy, wind and shade apparatus as set forth in claim 1, and further including more than three vertical posts for larger units.

4. The portable, adjustable, privacy, wind and shade apparatus as set forth in claim 1, and further including an adjustable connector that connects to a pair of horizontal poles and to the center vertical post; so that the apparatus can be positioned at an angle.
